(19) United States
(12) Patent Application Publication
(10) Pub. No.: US 2015/0065065 A1
(43) Pub. Date: Mar. 5, 2015

(54) RF TRANSCEIVER WITH ISOLATION TRANSFORMER AND METHODS FOR USE THEREWITH

(71) Applicant: BROADCOM CORPORATION, Irvine, CA (US)

(72) Inventors: Ahmadreza Rofougaran, Newport Coast, CA (US); Alireza Tarighat Mehrabani, Irvine, CA (US); Maryam Rofougaran, Rancho Palos Verdes, CA (US)

(21) Appl. No.: 14/027,869

(22) Filed: Sep. 16, 2013

Related U.S. Application Data
(60) Provisional application No. 61/872,979, filed on Sep. 3, 2013.

(51) Int. Cl. H04B 1/48; H04L 5/14

(52) U.S. Cl. CPC H04B 1/48; H04L 5/14
USPC 455/78

(57) ABSTRACT

A radio frequency (RF) transceiver includes an RF transmitter that generates a transmit signal based on outbound data for transmission to a remote communication device in a frequency band. An RF receiver generates inbound data based on a received signal from the remote communication device in the frequency band. An antenna section includes a shared antenna configurable for full-duplex transceiving of the transmit signal and the received signal and a center-tap isolation transformer configurable to isolate the transmit signal from the received signal.

### CROSS REFERENCE TO RELATED PATENTS

The present application claims priority based on 35 USC 119 to the provisionally filed application entitled, RF TRANSCEIVER WITH ISOLATION TRANSFORMER AND METHODS FOR USE THEREWITH, having Ser. No. 61/872,979, filed on Sep. 3, 2013, the contents of which are incorporated herein for any and all purposes, by reference thereto.

### BACKGROUND

1. Technical Field

Various embodiments relate generally to wireless communication and more particularly to communication devices that support full-duplex wireless communications.

2. Description of Related Art

Communication systems are known to support wireless and wireline communications between wireless and/or wireline communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, RFID, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Wireless communications occur within licensed or unlicensed frequency spectrums. For example, wireless local area network (WLAN) communications occur within the unlicensed Industrial, Scientific, and Medical (ISM) frequency spectrum of 900 MHz, 2.4 GHz, and 5 GHz. While the ISM frequency spectrum is unlicensed there are restrictions on power, modulation techniques, and antenna gain. Another unlicensed frequency spectrum is the millimeter wave V-band of 55-64 GHz.

### BRIEF DESCRIPTION OF THE SEVERAL VIEWS OF THE DRAWING(S)

FIG. 1 is a schematic block diagram of an embodiment of a wireless communication system;

FIG. 2 is a schematic block diagram of an embodiment of an RF transceiver 200;

FIG. 3 is a schematic block diagram of an embodiment of an antenna section 225;

FIG. 4 is a schematic block diagram of an embodiment of an antenna section 225 and an RF front-end 240′;

FIG. 5 is a flow diagram of an embodiment of a method;

FIG. 6 is a schematic block diagram of an embodiment of an antenna section 225′;

FIG. 7 is a schematic block diagram of an embodiment of an antenna section 225″.

### DETAILED DESCRIPTION

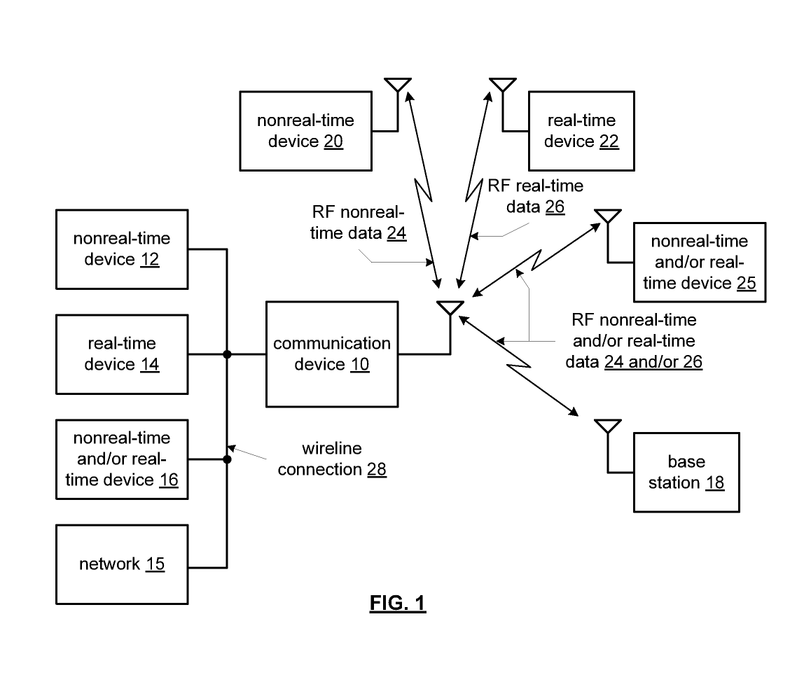

FIG. 1 is a schematic block diagram of an embodiment of a communication system. In particular a communication system is shown that includes a communication device 10 that communicates real-time data 26 and/or non-real-time data 24 wirelessly with one or more other devices such as base station 18, non-real-time device 20, real-time device 22, and non-real-time and/or real-time device 25. In addition, communication device 10 can also optionally communicate over a wireline connection with network 15, non-real-time device 12, real-time device 14, non-real-time and/or real-time device 16.

In an embodiment the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as WiHD, WiGig, NGMS, IEEE 802.11a, ac, ad, b, g, n, or other 802.11 standard protocol, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Long term Evolution (LTE), Personal Communication Services (PCS), or other mobile wireless protocol or other wireless communication protocol, either standard or proprietary. Further, the wireless communication path can include multiple transmit and receive antennas, as well as separate transmit and receive paths that use single carrier modulation to bi-directionally communicate data to and from the communication device 10.

Communication device 10 can be a mobile phone such as a cellular telephone, a local area network device, personal area network device or other wireless network device, a personal digital assistant, tablet, game console, personal computer, laptop computer, or other device that performs one or more functions that include communication of voice and/or data via the wireless communication path. Further communication device 10 can be an access point, base station or other network access device that is coupled to a network 15 such as the Internet or other wide area network, either public or private, via wireline connection 28. In an embodiment, the real-time and non-real-time devices 12, 14, 16, 20, 22 and 25 can be personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

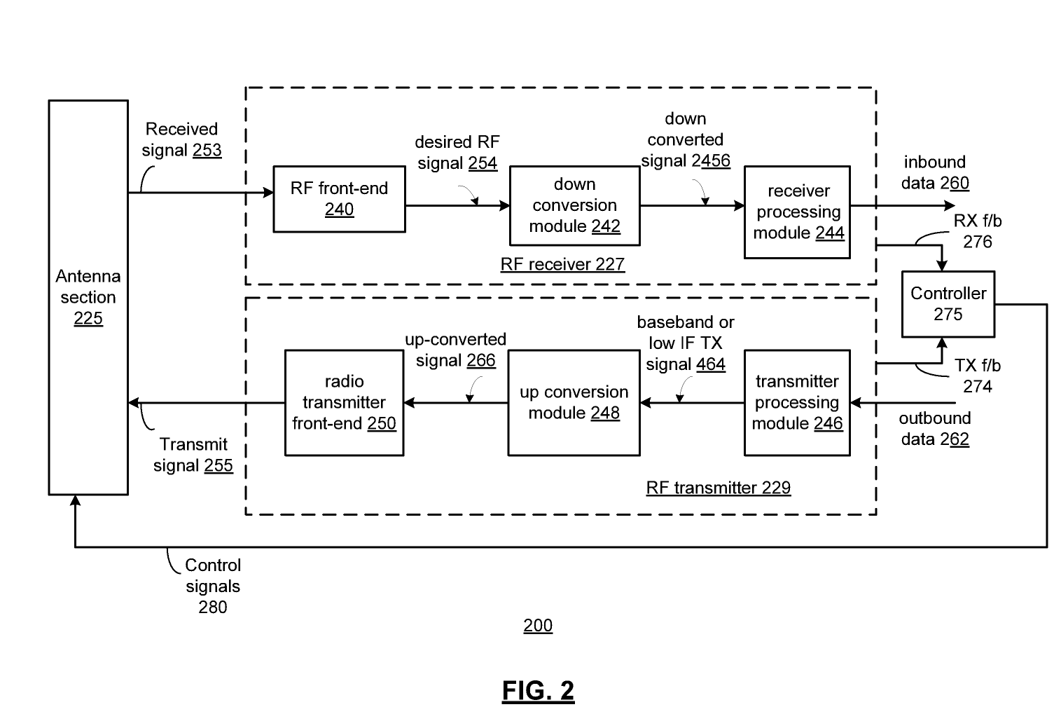

In an embodiment, the communication device 10 includes an RF transceiver that includes an antenna section for full-duplex operation that includes one or more features or functions of the various embodiments that are described in greater detail in association with FIGS. 2-5 that follow.

FIG. 2 is a schematic block diagram of an embodiment of an RF transceiver 202. In particular, an RF transceiver 202 includes an antenna section 225, RF receiver 227 and RF transmitter 229. The RF receiver 227 includes a RF front end 240, a down conversion module 242 and a receiver processing module 244. The RF transmitter 229 includes a transmitter processing module 246, an up conversion module 248, and a radio transmitter front-end 250.

In particular, the RF transmitter 229 generates a transmit signal 255 that is sent via antenna section 225 to a remote communication device. The transmit signal 255 is generated by RF transmitter 229 based on modulation of outbound data 262. In operation, the RF transmitter 229 receives outbound data 262. The transmitter processing module 246 packetizes outbound data 262 in accordance with a communication protocol, either standard or proprietary, to produce baseband or low intermediate frequency (IF) transmit (TX) signals 264 that includes an outbound symbol stream that contains outbound data 262. The baseband or low IF TX signals 264 may be digital baseband signals (e.g., have a zero IF) or digital low IF signals, where the low IF typically will be in a frequency range of one hundred kilohertz to a few megahertz. Note that the processing performed by the transmitter processing module 246 can include, but is not limited to, scrambling, encoding, puncturing, mapping, modulation, and/or digital baseband to IF conversion.

The up conversion module 248 includes a digital-to-analog conversion (DAC) module, a filtering and/or gain module, and a mixing section. The DAC module converts the baseband or low IF TX signals 264 from the digital domain to the analog domain. The filtering and/or gain module filters and/or adjusts the gain of the analog signals prior to providing it to the mixing section. The mixing section converts the analog baseband or low IF signals into up-converted signals 266 based on a transmitter local oscillation.

The radio transmitter front end 250 includes a power amplifier and may also include a transmit filter module. The power amplifier amplifies the up-converted signals 266 to produce transmit signal 255 which may be filtered by a transmitter filter module, if included.

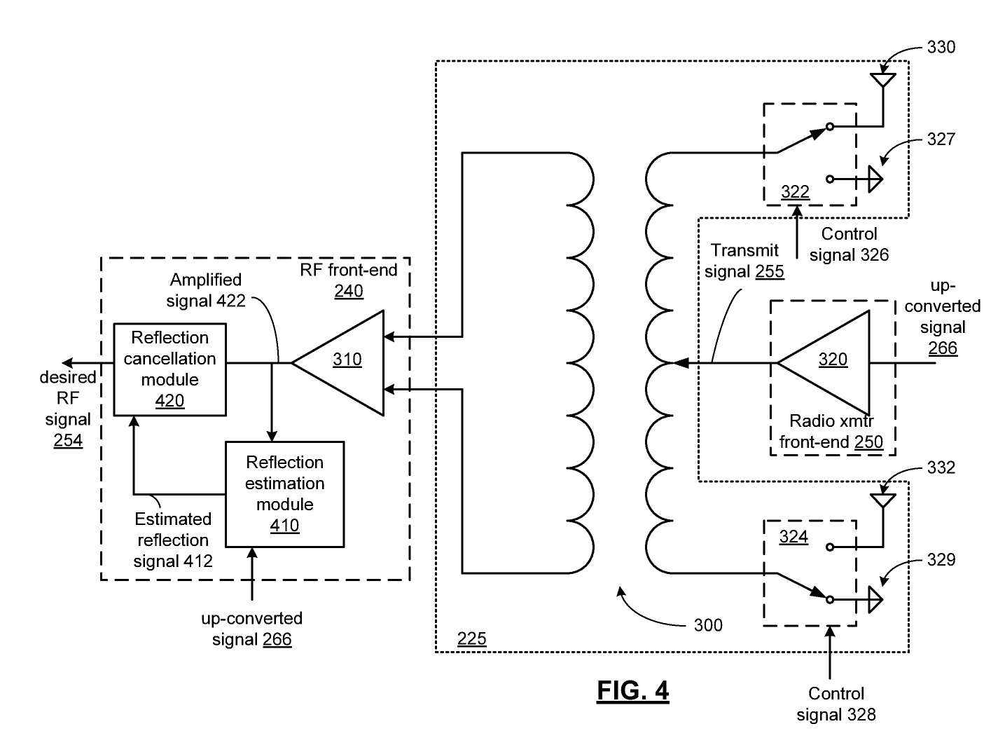

The RF receiver 227 generates inbound data 260 based on a received signal 253 received from the remote communication device via antenna section 225. The received signal 253 is amplified and optionally filtered by the receiver front-end 240 that generates a desired RF signal 254. As will be discussed in greater detail in conjunction with FIG. 4, the RF front-end 240 optionally includes reflection estimation and cancellation to cancel reflections of the transmit signal 255 that are included in the received signal 253. The down conversion module 242 includes a mixing section, an analog to digital conversion (ADC) module, and may also include a filtering and/or gain module. The mixing section converts the desired RF signal 254 into a down converted signal 256 that is based on a receiver local oscillation, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 256 that includes an inbound symbol stream. Note that the ordering of the ADC module and filtering and/or gain module may be switched, such that the filtering and/or gain module is an analog module.

The receiver processing module 244 processes the baseband or low IF signal 256 in accordance with a communication protocol, either standard or proprietary, to produce inbound data 260. The processing performed by the receiver processing module 244 can include, but is not limited to, digital intermediate frequency to baseband conversion, equalization, demodulation, demapping, depuncturing, decoding, and/or descrambling.

The transceiver 200 further includes a controller 275 that operates based on transmitter feedback 274 and receiver feedback 276 to generate control signals 280 that can be used to control or otherwise configure the antenna section 225. The transmitter feedback 274 can include an indication of transmit power, transmit/receive frequency, transmit modulation, transmit/receive polarization, a voltage standing wave ratio or other measure of antenna impedance or other transmitter parameters or measurements. The receiver feedback can indicate receive signal strength, signal to noise ratio, a receiver gain, transmit/receive frequency, transmit/receive polarization, bit error rate or other throughput indication, other transmit or receiver parameters received via inbound data 260 from a remote communication device such as a peer device, access point, base station or mobile communication device, or other receiver parameters or measurements.

In an embodiment, the controller 275, receiver processing module 244 and transmitter processing module 246 can be implemented via use of a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip. Such a memory device may be a read-only memory, random access memory, volatile memory, non-volatile memory, static memory, dynamic memory, flash memory, and/or any device that stores digital information. Note that when the processing devices implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry. While the controller 275, receiver processing module 244 and transmitter processing module 246 are shown separately, it should be understood that these elements could be implemented separately, together through the operation of one or more shared processing devices used for baseband processing of multiple RF sections or in any other combination of separate and/or shared processing.

In operation, the RF transmitter 229 and RF receiver 227 operate in the same frequency band, such as single carrier modulation with the same carrier frequency or multi-carrier modulation having spectra that have the same or similar frequency channels, or otherwise overlap in the frequency band. The antenna section 225 includes a shared antenna that is configurable for full-duplex transceiving of the transmit signal 255 and the received signal 253.

In an embodiment, the controller 275 generates control signals 280 that command the antenna section 225 to select the shared antenna as one of a plurality of antennas, such as antennas with different polarizations or other different configurations. The antenna section 225 further includes a center-tap isolation transformer configurable to isolate the transmit signal 255 from the received signal 253.

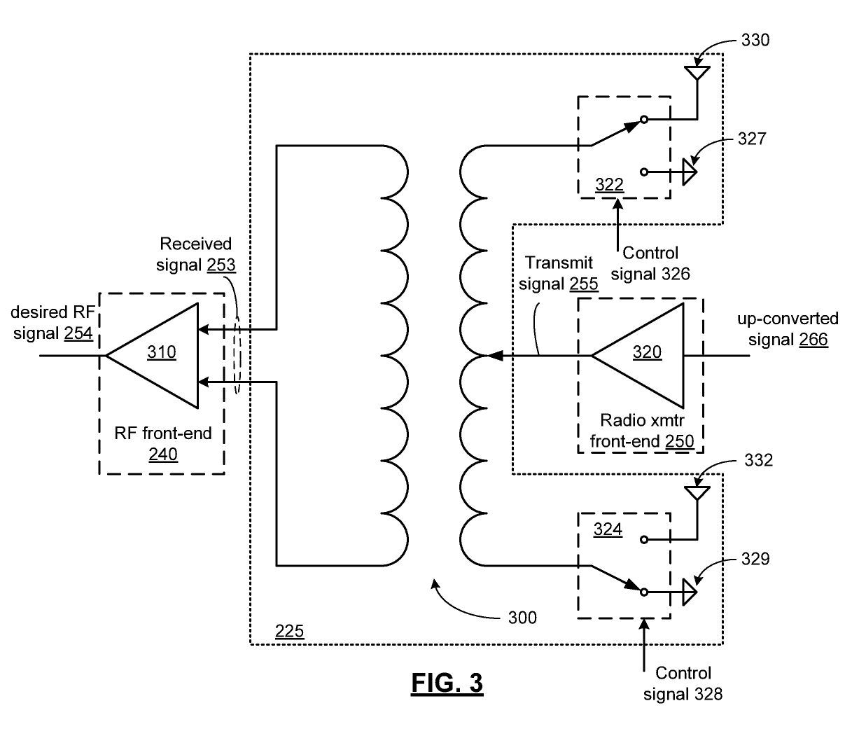

The antenna section 225 can include optional functions and features that are described in greater detail in association with FIGS. 3-5 that follow.

FIG. 3 is a schematic block diagram of an embodiment of an antenna section 225. A center-tap isolation transformer 300 includes a first winding with a center tap. A power amplifier 320 of radio transmitter front-end 250 generates the transmit signal 255 based on up-converted signal 266 and couples the transmit signal 255 to the center tap. The first winding is further coupled to switches 322 and 324 that operate based on control signals 326 and 328 to select either the antenna 330 or 332 as the shared antenna.

In the configuration shown, switch 322 couples the first winding of center-tap isolation transformer 300 to antenna 330. Switch 324 couples the first winding of center-tap isolation transformer 300 to termination 329. In another mode of operation, the switch 322 couples the first winding of center-tap isolation transformer 300 to termination 327 and switch 324 couples the first winding of center-tap isolation transformer 300 to antenna 332. In an embodiment, the terminations 327 and 329 are resistive terminations such as 50Q terminations or other resistive terminations that match the impedance of the antennas 330 and/or 332, however other termination configurations can be employed.

In an embodiment, the control signals 326 and 328, such as control signals 280 are generated by controller 275 that operates as a polarity setting module that operates in conjunction with RF transceiver 200 to select a desired polarity for communications with a remote device. In this embodiment, the antenna 326 and 328 can have differing polarizations (differing polarities) Herein, “polarity” refers the electric field polarity of transmitted wireless signal as it is radiated from the shared antenna, and may, for example, include a horizontal polarity, vertical polarity, righthand circular polarity, lefthand circular polarity or other polarity. In this fashion antenna section 225 can support fast polarity switching as described in conjunction with the copending application entitled, WIRELESS COMMUNICATION DEVICE WITH SWITCHED POLARIZATION AND METHODS FOR USE THEREWITH, Having Ser. No. 14,011,074 and filed on Aug. 27, 2013, the contents of which are incorporated herein by reference for any and all purposes.

In other embodiments, the antennas 330 and 332 can be spatial diverse, or of different configurations, operate in different frequency bands, or of other configurations and the control signals 326 and 328 can be generated by controller 275 to control the mode of operation of the antenna section 225 or otherwise, the mode of operation of the RF transceiver 200. For example, the decision to choose between 322 and 324, may depend on the antenna impendences of 330 and 332. The controller 275 can operate based on receiver feedback 274 and/or transmitter feedback 276 to generates control signal 326 and 328 to choose the antenna that is having better impedance matching or better propagation. This selection can be very dynamic as the channel conditions change or as the transceiver 200 proximity condition changes (hence resulting in changes in antenna impedance). This can provide selection diversity as well, as the antenna with best propagation path can be selected at any given instance.

The antenna (330 or 332) that is selected as the shared antenna is coupled via the second winding of the center-tap isolation transformer 300 to a low noise amplifier 310 of RF front-end 240 that receives the received signal 253 as a differential signal and that generates the desired RF signal 254 in response thereto. In operation, the center-tap isolation transformer 300 isolates the transmit signal 255 from the input of the low noise amplifier 310. In addition, the center-tap isolation transformer 300 isolates the received signal 253 from the output of the power amplifier 320. While not specifically shown, the center-tap isolation transformer 300 can include a magnetic core, such as a ferromagnetic core or other core. In an embodiment, the center-tap isolation transformer 300 can be implemented on-chip with all or part of the RF transceiver 200, can be implemented on a chip with components of antenna section 225 or be implemented as an off-chip component.

The use of antenna section 225 avoids sensitive antenna/PCB matching that can be a limitation with other full duplex solutions. In addition, the use of a single shared antenna can save cost and space as compared to other solutions that employ two TX antennas and one RX antenna (total of three physical antennas for each polarization or each other configuration).

It should be noted that while RF front-end 240 is shown as including low noise amplifier 310, it can contain other components such as filters, automatic gain control circuitry, etc. that are not specifically shown. It should be noted that while radio transmitter front-end 250 is shown as including power amplifier 320, it can contain other components such as filters, transmit power control circuitry, etc. that are not specifically shown.

FIG. 4 is a schematic block diagram of an embodiment of an antenna section 225 and an RF front-end 240′. In particular, similar components described in conjunction with FIG. 3 are shown with common reference numerals. In this embodiment, RF front-end 240′ further includes a reflection estimation module 410 and a reflection cancellation module 420.

In some cases, such as implementations in conjunction with mobile environments, the received signal 253 can include not only the desired RF signal 254, but a reflection of the transmit signal 255 generated by an external reflector. In the embodiment shown, the reflection estimation module 410 generates an estimated reflection signal 412 that estimates a reflection of the transmit signal 255 received by the shared antenna.

In particular, the reflection estimation module 410 uses the up-converted signal 266 or other signal from the radio transmitter front-end 250 to estimate the amplitude, phase and/or propagation delay associated with the reflection in the amplified signal 422 produced by low noise amplifier 310. The reflection estimation module 410 generates an estimated reflection signal 412, based on the up-converted signal 266 or other signal from the transmit path of radio transmitter front-end 250, having the same (or as close as possible) amplitude, phase and/or propagation delay. The reflection cancellation module 420 operates to cancel the reflection of the transmit signal 255 from a receive path of the RF front-end 240 by subtracting the estimated reflection signal 412 from the amplified signal 422.

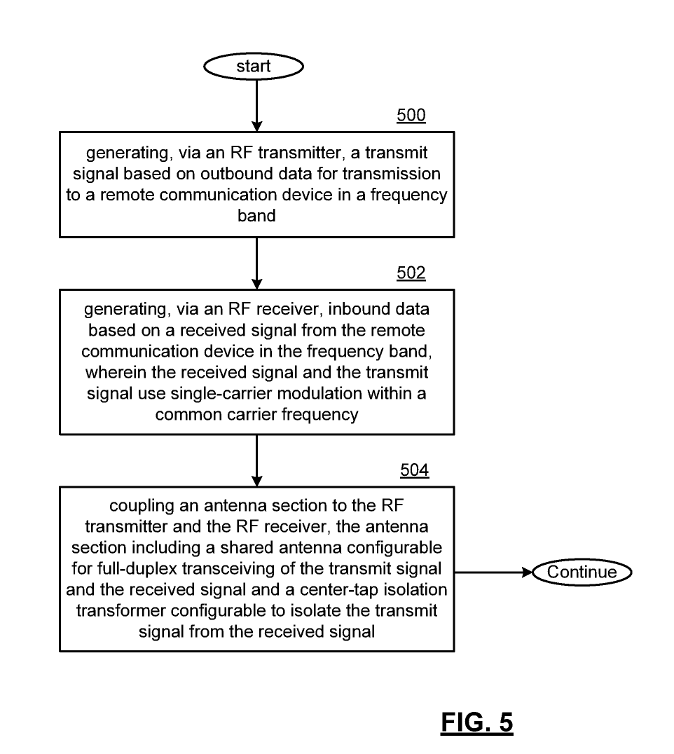

FIG. 5 is a flow diagram of an embodiment of a method. In particular, a method is presented for use in conjunction with the functions and features described in conjunction with FIGS. 1-4.

Step 500 includes generating, via an RF transmitter, a transmit signal based on outbound data for transmission to a remote communication device in a frequency band. Step 502 includes generating, via an RF receiver, inbound data based on a received signal from the remote communication device in the frequency band wherein the received signal and the transmit signal utilize overlapping portions of the frequency band.

Step 504 includes coupling an antenna section to the RF transmitter and the RF receiver, the antenna section including a shared antenna configurable for full-duplex transceiving of the transmit signal and the received signal and a center-tap isolation transformer configurable to isolate the transmit signal from the received signal.

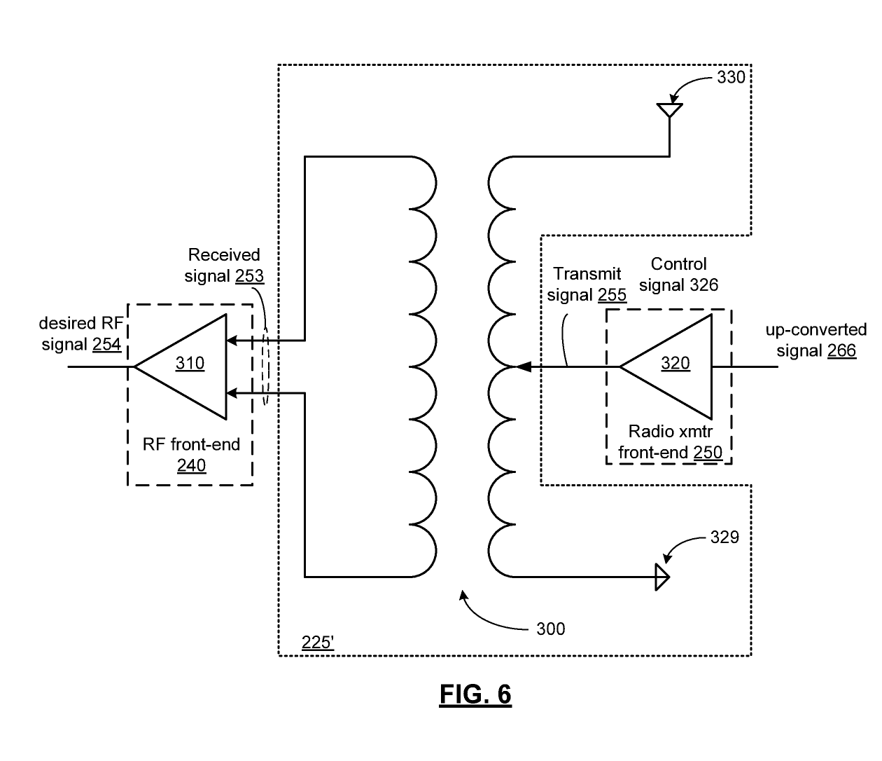

FIG. 6 is a schematic block diagram of an embodiment of an antenna section 225′. In particular, similar components described in conjunction with FIG. 3 are shown with common reference numerals. In this embodiment, to reduce costs, the antenna element 332 is eliminated. In such cases, antenna 330 is always used for communication and the center-tapped winding of center-tap transformer 300 is always connected to termination 329.

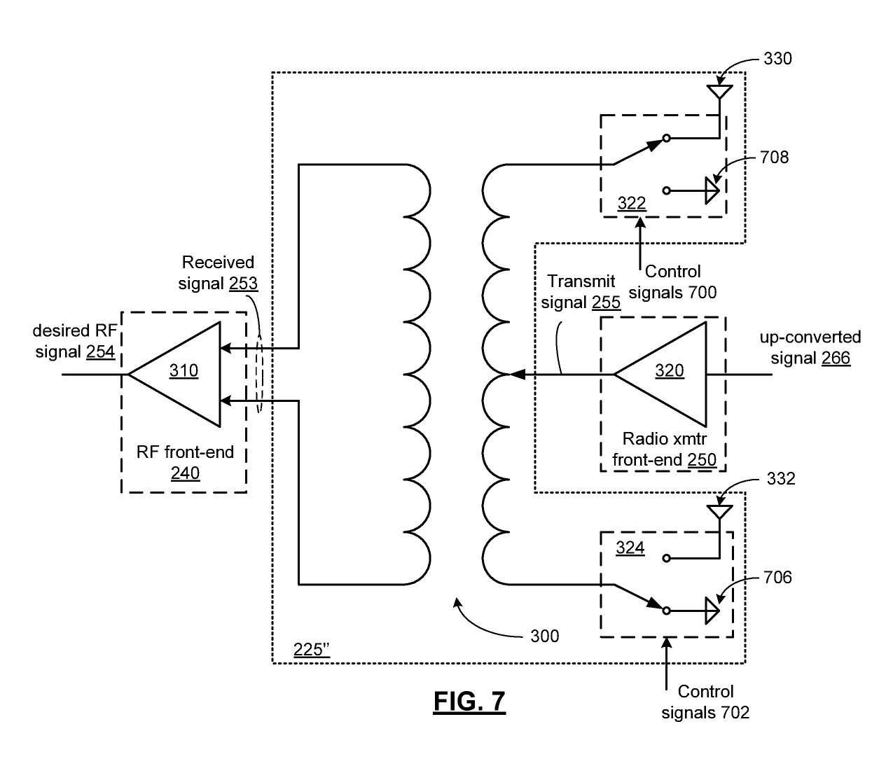

FIG. 7 is a schematic block diagram of an embodiment of an antenna section 225″. In particular, similar components described in conjunction with FIG. 3 are shown with common reference numerals. In this embodiment, terminations 704 and 706 have tunable impedances. For example, terminations 704 and 706 can be R, RL, RC or RLC circuits with an adjustable resistors (R), capacitors (C), and/or inductors (L).

Control signals 700 and 702 include not only control signals similar to control signals 326 and 328 described in conjunction with FIG. 3, but also control signals that control the overall impedance by controlling values of R, L and/or C of adjustable impedances 704 and 706. The control signals 700 and 702 can be generated by controller 275 as control signals 280. For example, as the antenna impedance of antenna 330 changes (due to holding of phone case, proximity objects, etc), the tunable impedance of termination 700 is programmed to match that of the antenna 330. Similarly as the antenna impedance of antenna 332 changes, the tunable impedance of termination 702 is programmed to match that of the antenna 332.

As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may also be used herein, the terms “processing module”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

Various embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

A physical embodiment of an apparatus, an article of manufacture, a machine, and/or of a process that includes one or more embodiments may include one or more of the aspects, features, concepts, examples, etc. described with herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” is used in the description of the various. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various options, methods, functions and features have been expressly described herein, other combinations of these options, methods, functions and features are likewise possible. The various embodiments are not limited by the particular examples disclosed herein and expressly incorporates these other combinations.

What is claimed is:

1. A radio frequency (RF) transceiver comprising:
an RF transmitter configured to generate a transmit signal based on outbound data for transmission to a remote communication device in a frequency band;
an RF receiver, coupled to the antenna array, configured to generate inbound data based on a received signal from the remote communication device in the frequency band; and
an antenna section, coupled to the RF transmitter and the RF receiver, includes a shared antenna configurable for full-duplex transceiving of the transmit signal and the received signal and further includes a center-tap isolation transformer configurable to isolate the transmit signal from the received signal.

2. The RF transceiver of claim 1 wherein the received signal and the transmit signal utilize overlapping portions of the frequency band.

3. The RF transceiver of claim 1 wherein the center-tap isolation transformer comprising a first winding with a center tap and wherein the RF transmitter couples the transmit signal to the center tap.

4. The RF transceiver of claim 3 wherein the first winding is further coupled to the shared antenna.

5. The RF transceiver of claim 4 wherein the center-tap isolation transformer comprising a second winding and wherein the RF receiver receives the received signal via the second winding.

6. The RF transceiver of claim 3 wherein the first winding is further coupled to select the shared antenna as one of a plurality of antennas.

7. The RF transceiver of claim 6 wherein the plurality of antennas comprising a plurality of different polarizations.

8. The RF transceiver of claim 1 further comprising:
a reflection estimation module, coupled to the RF transmitter, configurable to generate an estimated reflection signal that estimates a reflection of the transmit signal received by the shared antenna; and
a reflection cancellation, coupled to the RF receiver, configurable to cancel the reflection of the transmit signal from a receive path of the RF receiver.

9. The RF transceiver of claim 8 wherein the reflection estimation module generates the estimated reflection signal based on an upconverted signal from a transmit path of the RF transmitter.

10. The RF transceiver of claim 8 wherein the reflection estimation module estimates the reflection of the transmit signal based on an amplitude and a delay from an upconverted signal of a transmit path of the RF transmitter.

11. A radio frequency (RF) transceiver comprising:
an RF transmitter configured to generate a transmit signal based on outbound data for transmission to a remote communication device in a frequency band;
an RF receiver, coupled to the antenna array, configured to generate inbound data based on a received signal from the remote communication device in the frequency band; and
an antenna section, coupled to the RF transmitter and the RF receiver, is configurable to select a shared antenna as one of a plurality of antennas, is configurable for full-duplex transceiving of the transmit signal and the received signal and includes a center-tap isolation transformer configurable to isolate the transmit signal from the received signal.

12. The RF transceiver of claim 11 wherein the received signal and the transmit signal utilize overlapping portions of the frequency band.

13. The RF transceiver of claim 11 wherein the center-tap isolation transformer comprising a first winding with a center tap and wherein the RF transmitter couples the transmit signal to the center tap.

14. The RF transceiver of claim 13 wherein the first winding is further coupled to the shared antenna.

15. The RF transceiver of claim 14 wherein the center-tap isolation transformer comprising a second winding and wherein the RF receiver receives the received signal via the second winding.

16. The RF transceiver of claim 11 wherein the plurality of antennas have a plurality of different polarizations.

17. The RF transceiver of claim 11 further comprising:
a reflection estimation module, coupled to the RF transmitter, configurable to generate an estimated reflection signal that estimates a reflection of the transmit signal received by the shared antenna; and
a reflection cancellation, coupled to the RF receiver, configurable to cancel the reflection of the transmit signal from a receive path of the RF receiver.

18. The RF transceiver of claim 17 wherein the reflection estimation module generates the estimated reflection signal based on an upconverted signal from a transmit path of the RF transmitter.

19. The RF transceiver of claim 17 wherein the reflection estimation module estimates the reflection of the transmit signal based on an amplitude and a delay from an upconverted signal of a transmit path of the RF transmitter.

20. A method for use in a radio frequency (RF) transceiver, the method comprising:
generating, via an RF transmitter, a transmit signal based on outbound data for transmission to a remote communication device in a frequency band;
generating, via an RF receiver, inbound data based on a received signal from the remote communication device in the frequency band; and
coupling an antenna section to the RF transmitter and the RF receiver, the antenna section including a shared antenna configurable for full-duplex transceiving of the transmit signal and the received signal and a center-tap isolation transformer configurable to isolate the transmit signal from the received signal;
wherein the received signal and the transmit signal utilize overlapping portions of the frequency band.
